(19) United States
(12) Patent Application Publication
(10) Pub. No.: US 2014/0039101 A1
(43) Pub. Date: Feb. 6, 2014

(54) Synergistic Emulsion Polymer Formulation and Aqueous Coating/ Paint Compositions Involving the Same

(71) Applicant: Asian Paints Ltd., Mumbai (IN)

(72) Inventors: Vattipalli Mohan Rao, Navi Mumbai (IN); Vibha Tiwari, Navi Mumbai (IN); Avishek Mitra, Navi Mumbai (IN)

(73) Assignee: Asian Paints Ltd., Mumbai (IN)

(21) Appl. No.: 13/956,694

(22) Filed: Aug. 1, 2013

(30) Foreign Application Priority Data
Aug. 3, 2012 (IN) 2235/MUM/2012

(51) Int. Cl. C09D 7/12

(52) U.S. Cl. CPC C09D 7/1233
USPC 524/111; 524/753

(57) ABSTRACT

A synergistic emulsion polymer formulation adapted for facilitating achieving desired open time or wet edge time of any aqueous coating/paint composition on application to thus result in improved workability of the coating/paint composition. The synergistic emulsion polymer formulation and the coating/paint composition including the same comprises a latex polymer derived from copolymerization of mono-ethylenically unsaturated monomers. This in combination with select sorbitol ethoxylates esterified with fatty acids as an ingredient in the formulation/composition favors the slowing down of water evaporation from the composition considerably so that it remains amenable to touch up even after several minutes of application.

### RELATED APPLICATIONS

This application is related to and claims priority to Indian Patent Application No. 2235/MUM/2012 filed on Aug. 3, 2012.

### FIELD OF THE INVENTION

The present disclosure relates to a synergistic emulsion formulation adapted for facilitating achieving desired open time or wet edge time of any aqueous coating/paint composition on application to thus result in improved workability of said paint/coating compositions.

### BACKGROUND

Painting has always been an art and, for a skilled painter, workability of the paint is one of the additional tools at disposal to bring out the best out of his imagination. In conventional solvent-based alkyd paints the process of film formation involves evaporation of solvent followed by oxidative drying leading to build up of molecular weight and tack-free surface. The latter process is time taking giving opportunity for touch up. The incoming solvent during touch up helps the process of re-dispersing the polymer in the already applied coat.

### SUMMARY OF THE INVENTION

According to an embodiment of the invention, there is provided a synergistic emulsion formulation adapted for achieving desired open time or wet edge time of any aqueous coating/paint composition on application comprising a latex copolymer in combination with sorbitol ethoxylates esterified with fatty acids.

It is thus a selective finding of the present disclosure that a latex copolymer when present in synergistic combination with sorbitol ethoxylates esterified with fatty acids, results in a synergistic emulsion formulation which when incorporated in paint/coating formulation surprisingly facilitates the achievement of the desired open time or wet edge time by selectively slowing down water evaporation considerably from the resultant paint/coating compositions on application such that it remains amenable to touch up even after several minutes of application.

The selective ingredients offer flexibility of incorporation either at the stage of latex copolymer preparation or during paint preparation. However, the benefit in terms of gain in open time or wet edge time is higher when incorporated at the stage of latex copolymer preparation as opposed to their incorporation during paint preparation. Most advantageously, within the process of latex copolymer preparation, the selective ingredient of sorbitol ethoxylates esterified with fatty acids can be incorporated at more than one stage of polymer emulsion preparation to impart equal effectiveness in the achievement of the gain in open time or wet edge time in formulations/compositions involving it.

According to another embodiment of the invention, there is provided a synergistic emulsion formulation wherein the sorbitol ethoxylates esterified with fatty acids is selected from a class of sorbitol ethoxylates esterified with fatty acids having the general formula, C₆H₈(OH)_{6-b}(OCH₂CH₂)ₘ(R¹COO)_{b} wherein: b is an integer from 1 to 6, R¹ is a hydrocarbon group comprising a straight chain of alkyl groups having 6 to 22 carbon atoms and m is in the range of 4 to 60. Preferably, the number of oxyethylene groups (OCH₂CH₂) denoted by the value m is in the range of 40 to 60.

According to another embodiment of the invention, a synergistic emulsion formulation is provided wherein the sorbitol ethoxylates esterified with fatty acids are incorporated in the amounts of 0.1% to 10% in said formulation.

According to yet another embodiment of the invention, a synergistic emulsion formulation is provided wherein the latex copolymer is film forming and can have a glass transition temperature in the range of −15° C. to +50° C. obtained from ethylenically unsaturated monomers.

According to another embodiment of the invention, there is provided the synergistic emulsion formulation wherein the latex copolymer is obtained of ethylenically unsaturated monomers selected from anyone or more of: a) acrylic acid esters and methacrylic acid esters of alcohols having 1 to 18 carbon atoms, most preferably methyl acrylate, ethyl acrylate, butyl acrylate, 2-ethylhexyl acrylate, methyl methacrylate, ethyl methacrylate and butyl methacrylate; b) hydroxy alkyl acrylates such as hydroxy ethyl methacrylate, hydroxy propyl methacrylate; c) mono ethylenically unsaturated hydrocarbons such as styrene; and d) acid monomers such as acrylic and methacrylic acids.

According to another embodiment of the invention, there is provided a process of manufacturing the synergistic emulsion formulation comprising ethylenically unsaturated monomers and select sorbitol ethoxylates esterified with fatty acids. According to another embodiment of the invention, there is provided the process wherein the step of providing sorbitol ethoxylates esterified with fatty acids in combination with a latex copolymer comprises either: (i) incorporating the sorbitol ethoxylates esterified with fatty acids at the time of polymerization; or (ii) incorporating the sorbitol ethoxylates esterified with fatty acids post polymerization.

According to another embodiment of the invention, there is provided a synergistic aqueous coating/paint composition having a desired open time or wet edge time on application comprising: (a) a synergistic emulsion formulation comprising a latex copolymer in combination with sorbitol ethoxylates esterified with fatty acids; and (b) a coating/paint formulation.

According to another embodiment of the invention, there is provided the synergistic aqueous coating/paint composition, wherein the desired open time or wet edge time of the composition on application is in the range of 5 to 6 minutes.

According to yet another embodiment of the invention, a process of manufacturing the synergistic aqueous coating/paint composition having a desired open time or wet edge time on application comprises the steps of:
(i) providing synergistic emulsion formulation comprising a latex copolymer in combination with sorbitol ethoxylates esterified with fatty acids; and
(ii) adding the synergistic emulsion formulation of step (i) above to the aqueous coating/paint formulation.

According to another embodiment of the invention, a process of manufacturing the synergistic aqueous coating/paint composition having a desired open time or wet edge time on application comprises the steps of:
I. preparing latex copolymers involving the steps of:
(a) providing monomers for polymerization; and
(b) obtaining the latex copolymers therefrom comprising pre-emulsion of latex copolymers; and
II. preparing the synergistic aqueous coating/paint composition involving the sorbitol ethoxylates esterified with fatty acids and the latex copolymers obtained from step (I) above.

The sorbitol ethoxylates esterified with fatty acids are preferably incorporated in the amounts of 0.1% to 10% in the coating/paint composition.

According to another embodiment of the invention, a method of coating/painting any surface using the synergistic emulsion formulation adapted for facilitating achieving desired open time or wet edge time comprises the steps of:
(i) providing the emulsion formulation comprising a latex copolymer in combination with sorbitol ethoxylates esterified with fatty acids; and
(ii) incorporating the emulsion formulation in a coating/paint formulation and thereafter applying it on a surface to attain a desired open time or wet edge time in the range of 5 to 6 minutes.

### DETAILED DESCRIPTION OF THE INVENTION

Use of solvent borne paints is on the decline for a variety of reasons, prime ones among them being, toxicity of the solvents and concerns regarding volatile organic components affecting the environment. These concerns have driven the world towards water-borne technology. It is also known that the process of film formation in aqueous coatings such as those based on emulsion or latex polymers involves evaporation of water followed by polymer particles coming in contact with each other. This is subsequently followed by migration of polymer chains across the particle boundaries leading to film formation. So long as the polymer particles do not come in contact with each other and so long as the migration of polymer chains across particle boundaries does not commence, the coating remains amenable to touch up. But the aqueous coatings such as those based on emulsion polymers have a tendency to dry instantly upon application over a substrate as the phenomena of film formation basically involves only evaporation of water followed by coalescence of discrete polymer particles. The process of water evaporation gets faster by the surrounding environment having less and less of humidity. Thus, the problems relating to touch up of freshly painted surface becomes more acute while dealing with hot, dry or windy conditions.

Workability of paint is often referred to as wet edge or open time. Open time or wet edge time can be defined as the period of time during which a painter can make corrections to the freshly applied wet paint film without leaving brush marks.

Even in humid conditions, the available wet edge time remains of the order 2 to 4 minutes for most commonly available aqueous coatings in the market. The corresponding open time may be manageable for a normal paint application with routine needs of retouching of a painted area. However, the problem becomes acute while creating effect finishes where more time is required to apply the multiple tools necessary to develop patterns.

Earlier approaches mainly focused on suppressing the evaporation rate of water by addition of organic solvents like propylene glycol, etc to achieve a higher open time or wet edge time. While these had provided some success the limitations were obvious. High levels of solvents resulted in drastic reduction in paint solids which in turn adversely affected surface obliteration upon paint application. Secondly, the approach was not compatible from environmental and toxicological point of view which gave a major thrust towards exploring water based coatings/paints with improvement in wet edge time or open time.

Hence, as would be apparent from the above discussion, there still remains a long felt need in the art to further explore for improved water based coating/paint compositions having extended open time or wet edge time, which on one hand would be non-toxic and environmentally safe in being water based and on the other would possess significantly improved open time or wet edge time to thus remain amenable to touch up on application for an extended period of time due to its considerably slow water evaporation characteristics.

In accordance with one embodiment of the invention, a synergistic emulsion formulation is disclosed. The synergistic emulsion formulation comprises selective ingredients and aqueous coating/paint composition involving the same having a prolonged open time or wet edge time so that the coating/paint composition remains amenable to touch up even after several minutes of application.

In accordance with another embodiment of the invention, the coating/paint composition and processes to reach to the same that is water based and yet would possess a desired and extended open time or wet edge time are disclosed.

In accordance with yet another embodiment of the invention, the coating/paint composition is water based and free from the use of organic solvents in it so that it is non-toxic and environmentally safe in being water based but would still possess significantly improved open time or wet edge time adapted for improved workability of the aqueous paint/coating composition.

In accordance with one embodiment, an aqueous paint/coating compositions and a method of coating/painting any surface using the same to attain a desired open time or wet edge time due to slowing down of water evaporation from the paint/coating compositions considerably after application are disclosed.

The one or more embodiments of the invention provide for a synergistic emulsion formulation adapted for facilitating achieving desired open time or wet edge time of any aqueous coating/paint composition on application to thus result in improved workability of said paint/coating compositions. The synergistic emulsion formulation of the present invention and coating/paint composition involving the same comprises a latex copolymer derived from copolymerization of mono-ethylenically unsaturated monomers which in combination with selective sorbitol ethoxylates esterified with fatty acids, as an ingredient in the formulation/composition, selectively favours slowing down of water evaporation from the composition considerably on application such that the paint/coating composition remains amenable to touch up thereby achieving the desired open time or wet edge time.

The selective sorbitol ethoxylates esterified with fatty acids as an ingredient in the formulation/composition of an embodiment of the invention in comprising hydrophobic groups on one end and hydrophilic groups at the other end, wherein the hydrophilic groups extend deep into the surrounding aqueous phase, and the hydrophobic portion of the selective additive adsorbs onto the particle surface, and wherein association of aqueous phase water molecules with the hydrophilic portion of the additive through hydrogen bonding and other such phenomena surprisingly favors in setting up of a barrier against coming together of the polymer particles. The net effect is one of decelerating the process of coming together of the latex particles wherein the hydrophilic groups cause slowing down of water evaporation considerably such that the paint/coating composition comprising the said ingredient remains amenable to touch up thereby achieving the desired open time or wet edge time.

A key aspect of the selective ingredient of an embodiment of the invention is that not only they hydrogen bond with the water molecules present in the continuous phase of the coating but also unexpectedly adsorbs onto the latex particle surface at the same time. These two properties working in unison make the additives more effective in improving the open time or wet edge time of the paint/coating composition in which they are present. Needless to state, however, that the scope of the present invention is not bound by the theoretical reasoning given above.

Further to this it was observed by way of the experiments illustrated hereunder, in the one or more embodiments of the invention, that while the selective ingredient sorbitol ethoxylates esterified with fatty acids offers flexibility of incorporation at both the latex based polymer emulsion preparation stage or paint preparation stage it is beneficial to add the selective ingredient at the polymer preparation stage as compared to the paint preparation stage for better gain in open time or wet edge time of the coating/composition involving the same.

According to another embodiment of the invention, the ingredient referred to here are polyethoxylated fatty acid esters of sorbitol having the general formula C₆H₈(OH)_{6-b}(OCH₂CH₂)ₘ(R¹COO)_{b} where b is an integer from 1 to 6, R¹ is a hydrocarbon group comprising a straight chain of alkyl groups having 6 to 22 carbon atoms and m is an integer from 4 to 60 denotes the number of oxyethylene groups (OCH₂CH₂). R¹ is the hydrophobic portion and the remainder of the molecule is hydrophilic portion. These compounds, commercially available from Croda Inc under the trade names of Cirrasol G 1086 and Cirrasol G 1096; formerly ICI Americas as Atlas G 1086 and Atlas G 1096; are the following where the value of m is in parenthesis after “polyoxyethylene”: polyoxyethylene (50) sorbitol hexaoleate (G-1096) and polyoxyethylene (40) sorbitol hexaoleate (G-1086). It may be emphasized that these are structurally different from polyethoxylated sorbitan fatty acid esters (Tween). The usage level of these additives is 0.1% to 10%, preferably 0.2% to 5.0% and more preferably 1% to 3%.

Suitable emulsion polymers useful in formulating the aqueous coatings of the one or mor eembodiments of the invention are made by conventional emulsion polymerization techniques well known in the art. These may be copolymers of: 1) acrylic acid esters and methacrylic acid esters of alcohols having 1 to 18 carbon atoms, most preferably selected from anyone or more of methyl acrylate, ethyl acrylate, butyl acrylate, 2-ethylhexyl acrylate, methyl methacrylate, ethyl methacrylate and butyl methacrylate; 2) hydroxy alkyl acrylates selected from anyone or more of hydroxy ethyl methacrylate, hydroxy propyl methacrylate; and 3) mono ethylenically unsaturated hydrocarbons selected from styrene.

In another embodiment of the invention, a small amount such as 0.5% to 5.0%, preferably 0.5% to 2.0% and more preferably 0.5% to 1.0% of an acid monomer is included in the monomer mixture for making the copolymers. Such acid monomers include acrylic and methacrylic acids.

Other ingredients useful for preparation of emulsion polymers, known in the art, are free radical generators which can be thermal initiators like ammonium persulphate, potassium persulphate or redox pairs like tertiary butyl hydroperoxide-sodium formaldehyde sulfoxylate, chain transfer agents for control of molecular weight of the polymer, buffers for control of pH during polymerization, de-foamers for control of foaming during polymerization, surfactants, in-can preservatives to protect the aqueous system against microbial attack, neutralizing agents such as ammonia, aminoalcohol.

In one embodiment of the invention, the latex polymer is prepared by the conventional techniques well known in the art of emulsion polymeri[[s]]zation. The particle size of the emulsions is in the range of 50 nanometers to 300 nanometers, preferably 100 to 200 nanometers. The term ‘particle size’ as used herein is the median diameter value expressed in nanometers and can be determined by dynamic light scattering or by electron microscopy. The morphology of the particles is not critical. The particles may be a single phase or composed of two or more phases such as core/shell particles, core/shell particles. The shell phase may or may not completely encapsulate the core. Preferably the emulsion polymers employed in the present invention are those capable of forming a continuous film upon drying at temperatures in the range of 0 to 50° C., preferably 0 to 30° C. and more preferably 0 to 15° C.

The open time or wet edge time of an aqueous coating may be measured by several methods reported in the literature. In one or more embodiments of the invention, the substrate employed can also vary from glass plate, Leneta paper, gypsum board or concrete surface. The substrate employed here was concrete wall as such. Wet edge times were measured by recoating the edge of a painted surface, typically 1 ft×2 ft patch, after fixed intervals of time and observation for appearance of lap lines in the overlap area. The overlap area was maintained at least 3 inches width. The temperature and humidity conditions were controlled using standard equipment.

The one or more embodiments of the invention are further explained in greater detail in relation to the following non-limiting examples.

### EXAMPLE-1

### Control Latex Polymer Preparation

A polymerization reactor equipped with metering devices and temperature regulators was charged with 0.12 g Potassium persulphate, 0.20 g Sodium bicarbonate and 0.40 g Dowfax 2A1 (commercially available from Dow Chemicals, USA) and 18 g water. The contents were heated to 45° C. under agitation. In a separate glass vessel 4.0 g styrene, 18.6 g Methylmethacrylate, 22.05 g Butyl acrylate, 0.99 g Methacrylic acid, 1.5 g Hydroxyethyl methacrylate, 23.54 g water, 0.12 g potassium persulphate, 0.7 g Dowfax 2A1 and 1.50 g Lissapol 3070 (Nonyl phenol 30 mole ethoxylate of 70% concentration, commercially available from Croda Inc) were subjected to gentle agitation. This resulted in milky white ‘pre-emulsion’ formation. 2.2 g of this pre-emulsion was added to the polymerization reactor whose contents were already at 45° C. The temperature of the reactor contents was raised to 76° C. at a heating rate of 2° C. per minute. The agitation was continued for a further period of 2 to 3 minutes after which the contents were examined for presence of any unreacted monomer through de-wetting check. The de-wetting check involved drawing a small quantity of the sample and spreading it on a clean glass plate. Uniform wetting of the glass plate surface indicated absence of unreacted monomer. Subsequently, the pre-emulsion from the separate glass vessel was added to the reactor at a uniform rate over a period of 4 hrs. The temperature of the reactor contents was maintained throughout at 78±2° C. The contents were held under agitation for a further period of 30 minutes at 78±2° C. To the contents of the reactor, 0.08 g of Tertiary butyl hydro peroxide dispersed in 0.4 g water was added and agitation continued. To the contents of the reactor, 2.5 ml of 3% solution of sodium formaldehyde sulfoxylate was added drop-wise over a period of 15 minutes. Agitation continued for a further period of 45 minutes holding the temperature at 78±2° C. after which the contents were cooled to 40° C. over a period of 1 hour. Additives such as 0.1 g Nipacide CFX (commercially available from Clariant Corporation), 0.02 g of 18% Dapro 4164 dispersion in water and 0.80 g 15% active ammonia were added. To ensure accurate addition of additives rinsing was done using small quantities of water at each additive handling. Total of 3 g water was used for rinsing purpose. The pH of the emulsion should lie in the range of 8.0-9.0.

### EXAMPLE-2

### Latex Polymer with the Ingredient of the Present Invention Incorporated During Polymerization

A polymerization reactor equipped with metering devices and temperature regulators was charged with 0.12 g Potassium persulphate, 0.20 g Sodium bicarbonate and 0.40 g Dowfax 2A1 (commercially available from Dow Chemicals, USA) and 18 g water. The contents were heated to 45° C. under agitation. In a separate glass vessel 4.0 g styrene, 18.6 g Methylmethacrylate, 22.05 g Butyl acrylate, 0.99 g Methacrylic acid, 1.5 g Hydroxyethyl methacrylate, 23.14 g water, 0.12 g potassium persulphate, 0.7 g Dowfax 2A1 and 1.90 g Atlas G 1086 (commercially available from Croda Inc) were subjected to gentle agitation. This resulted in milky white ‘pre-emulsion’ formation. 2.2 g of this pre-emulsion was added to the polymerization reactor whose contents were already at 45° C. The temperature of the reactor contents was raised to 76° C. at a heating rate of 2° C. per minute. The agitation was continued for a further period of 2 to 3 minutes after which the contents were examined for presence of any unreacted monomer through de-wetting check. The de-wetting check involved drawing a small quantity of the sample and spreading it on a clean glass plate. Uniform wetting of the glass plate surface indicated absence of unreacted monomer. Subsequently, the pre-emulsion from the separate glass vessel was added to the reactor at a uniform rate over a period of 4 hrs. The temperature of the reactor contents was maintained throughout at 78±2° C. The contents were held under agitation for a further period of 30 minutes at 78±2° C. To the contents of the reactor, 0.08 g of Tertiary butyl hydro peroxide dispersed in 0.4 g water was added and agitation continued. To the contents of the reactor, 2.5 ml of 3% solution of sodium formaldehyde sulfoxylate was added drop-wise over a period of 15 minutes. Agitation continued for a further period of 45 minutes holding the temperature at 78±2° C. after which the contents were cooled to 40° C. over a period of 1 hour. Additives such as 0.1 g Nipacide CFX (commercially available from Clariant Corporation), 0.02 g of 18% Dapro 4164 dispersion in water and 0.80 g 15% active ammonia were added. To ensure accurate addition of additives rinsing was done using small quantities of water at each additive handling. Total of 3 g water was used for rinsing purpose. The pH of the emulsion should lie in the range of 8.0-9.0.

### EXAMPLE-3

### Latex Polymer with the Ingredient of the Present Invention Incorporated After Polymerization

A polymerization reactor equipped with metering devices and temperature regulators was charged with 0.12 g Potassium persulphate, 0.20 g Sodium bicarbonate and 0.40 g Dowfax 2A1 (commercially available from Dow Chemicals, USA) and 18 g water. The contents were heated to 45° C. under agitation. In a separate glass vessel 4.0 g styrene, 18.6 g Methylmethacrylate, 22.05 g Butyl acrylate, 0.99 g Methacrylic acid, 1.5 g Hydroxyethyl methacrylate, 23.14 g water, 0.12 g potassium persulphate, 0.7 g Dowfax 2A1 were subjected to gentle agitation. This resulted in milky white ‘pre-emulsion’ formation. 2.2 g of this pre-emulsion was added to the polymerization reactor whose contents were already at 45° C. The temperature of the reactor contents was raised to 76° C. at a heating rate of 2° C. per minute. The agitation was continued for a further period of 2 to 3 minutes after which the contents were examined for presence of any unreacted monomer through de-wetting check. The de-wetting check involved drawing a small quantity of the sample and spreading it on a clean glass plate. Uniform wetting of the glass plate surface indicated absence of unreacted monomer. Subsequently, the pre-emulsion from the separate glass vessel was added to the reactor at a uniform rate over a period of 4 hrs. The temperature of the reactor contents was maintained throughout at 78±2° C. The contents were held under agitation for a further period of 30 minutes at 78±2° C. To the contents of the reactor, 1.90 g of Atlas G 1086 was added followed by 0.08 g of Tertiary butyl hydro peroxide dispersed in 0.4 g water was added and agitation continued. To the contents of the reactor, 2.5 ml of 3% solution of sodium formaldehyde sulfoxylate was added drop-wise over a period of 15 minutes. Agitation continued for a further period of 45 minutes holding the temperature at 78±2° C. after which the contents were cooled to 40° C. over a period of 1 hour. Additives such as 0.1 g Nipacide CFX (commercially available from Clariant Corporation), 0.02 g of 18% Dapro 4164 dispersion in water and 0.80 g 15% active ammonia were added. To ensure accurate addition of additives rinsing was done using small quantities of water at each additive handling. Total of 3 g water was used for rinsing purpose. The pH of the emulsion should lie in the range of 8.0-9.0.

### EXAMPLE-4

### Latex Polymer with Another Ingredient of the Present Invention Incorporated During Polymerization

A polymerization reactor equipped with metering devices and temperature regulators was charged with 0.12 g Potassium persulphate, 0.20 g Sodium bicarbonate and 0.40 g Dowfax 2A1 (commercially available from Dow Chemicals, USA) and 18 g water. The contents were heated to 45° C. under agitation. In a separate glass vessel 4.0 g styrene, 18.6 g Methylmethacrylate, 22.05 g Butyl acrylate, 0.99 g Methacrylic acid, 1.5 g Hydroxyethyl methacrylate, 23.14 g water, 0.12 g potassium persulphate, 0.7 g Dowfax 2A1 and 1.90 g Atlas G 1096 (also commercially available from Croda Inc) were subjected to gentle agitation. This resulted in milky white ‘pre-emulsion’ formation. 2.2 g of this pre-emulsion was added to the polymerization reactor whose contents were already at 45° C. The temperature of the reactor contents was raised to 76° C. at a heating rate of 2° C. per minute. The agitation was continued for a further period of 2 to 3 minutes after which the contents were examined for presence of any unreacted monomer through de-wetting check. The de-wetting check involved drawing a small quantity of the sample and spreading it on a clean glass plate. Uniform wetting of the glass plate surface indicated absence of unreacted monomer. Subsequently, the pre-emulsion from the separate glass vessel was added to the reactor at a uniform rate over a period of 4 hrs. The temperature of the reactor contents was maintained throughout at 78±2° C. The contents were held under agitation for a further period of 30 minutes at 78±2° C. To the contents of the reactor, 0.08 g of Tertiary butyl hydro peroxide dispersed in 0.4 g water was added and agitation continued. To the contents of the reactor, 2.5 ml of 3% solution of sodium formaldehyde sulfoxylate was added drop-wise over a period of 15 minutes. Agitation continued for a further period of 45 minutes holding the temperature at 78±2° C. after which the contents were cooled to 40° C. over a period of 1 hour. Additives such as 0.1 g Nipacide CFX (commercially available from Clariant Corporation), 0.02 g of 18% Dapro 4164 dispersion in water and 0.80 g 15% active ammonia were added. To ensure accurate addition of additives rinsing was done using small quantities of water at each additive handling. Total of 3 g water was used for rinsing purpose. The pH of the emulsion should lie in the range of 8.0-9.0.

### EXAMPLE-5

### Latex Polymer with Lesser Quantity of the Ingredient of the Present Invention Incorporated During Polymerization

A polymerization reactor equipped with metering devices and temperature regulators was charged with 0.12 g Potassium persulphate, 0.20 g Sodium bicarbonate and 0.40 g Dowfax 2A1 (commercially available from Dow Chemicals, USA) and 18 g water. The contents were heated to 45° C. under agitation. In a separate glass vessel 4.0 g styrene, 18.6 g Methylmethacrylate, 22.05 g Butyl acrylate, 0.99 g Methacrylic acid, 1.5 g Hydroxyethyl methacrylate, 23.14 g water, 0.12 g potassium persulphate, 0.7 g Dowfax 2A1 and 0.95 g Atlas G 1086 were subjected to gentle agitation. This resulted in milky white ‘pre-emulsion’ formation. 2.2 g of this pre-emulsion was added to the polymerization reactor whose contents were already at 45° C. The temperature of the reactor contents was raised to 76° C. at a heating rate of 2° C. per minute. The agitation was continued for a further period of 2 to 3 minutes after which the contents were examined for presence of any unreacted monomer through de-wetting check. The de-wetting check involved drawing a small quantity of the sample and spreading it on a clean glass plate. Uniform wetting of the glass plate surface indicated absence of unreacted monomer. Subsequently, the pre-emulsion from the separate glass vessel was added to the reactor at a uniform rate over a period of 4 hrs. The temperature of the reactor contents was maintained throughout at 78±2° C. The contents were held under agitation for a further period of 30 minutes at 78±2° C. To the contents of the reactor, 0.08 g of Tertiary butyl hydro peroxide dispersed in 0.4 g water was added and agitation continued. To the contents of the reactor, 2.5 ml of 3% solution of sodium formaldehyde sulfoxylate was added drop-wise over a period of 15 minutes. Agitation continued for a further period of 45 minutes holding the temperature at 78±2° C. after which the contents were cooled to 40° C. over a period of 1 hour. Additives such as 0.1 g Nipacide CFX (commercially available from Clariant Corporation), 0.02 g of 18% Dapro 4164 dispersion in water and 0.80 g 15% active ammonia were added. To ensure accurate addition of additives rinsing was done using small quantities of water at each additive handling. Total of 3 g water was used for rinsing purpose. The pH of the emulsion should lie in the range of 8.0-9.0.

### EXAMPLE-6

### Latex Polymer Incorporating Tween-80 During Polymerization

A polymerization reactor equipped with metering devices and temperature regulators was charged with 0.12 g Potassium persulphate, 0.20 g Sodium bicarbonate and 0.40 g Dowfax 2A1 (commercially available from Dow Chemicals, USA) and 18 g water. The contents were heated to 45° C. under agitation. In a separate glass vessel 4.0 g styrene, 18.6 g Methylmethacrylate, 22.05 g Butyl acrylate, 0.99 g Methacrylic acid, 1.5 g Hydroxyethyl methacrylate, 23.14 g water, 0.12 g potassium persulphate, 0.7 g Dowfax 2A1 and 1.90 g Tween-80 (commercially available from Croda Inc) were subjected to gentle agitation. This resulted in milky white ‘pre-emulsion’ formation. 2.2 g of this pre-emulsion was added to the polymerization reactor whose contents were already at 45° C. The temperature of the reactor contents was raised to 76° C. at a heating rate of 2° C. per minute. The agitation was continued for a further period of 2 to 3 minutes after which the contents were examined for presence of any unreacted monomer through de-wetting check. The de-wetting check involved drawing a small quantity of the sample and spreading it on a clean glass plate. Uniform wetting of the glass plate surface indicated absence of unreacted monomer. Subsequently, the pre-emulsion from the separate glass vessel was added to the reactor at a uniform rate over a period of 4 hrs. The temperature of the reactor contents was maintained throughout at 78±2° C. The contents were held under agitation for a further period of 30 minutes at 78±2° C. To the contents of the reactor, 0.08 g of Tertiary butyl hydro peroxide dispersed in 0.4 g water was added and agitation continued. To the contents of the reactor, 2.5 ml of 3% solution of sodium formaldehyde sulfoxylate was added drop-wise over a period of 15 minutes. Agitation continued for a further period of 45 minutes holding the temperature at 78±2° C. after which the contents were cooled to 40° C. over a period of 1 hour. Additives such as 0.1 g Nipacide CFX (commercially available from Clariant Corporation), 0.02 g of 18% Dapro 4164 dispersion in water and 0.80 g 15% active ammonia were added. To ensure accurate addition of additives rinsing was done using small quantities of water at each additive handling. Total of 3 g water was used for rinsing purpose. The pH of the emulsion should lie in the range of 8.0-9.0.

### EXAMPLE-7

### Paint Preparation Upon Incorporation of the Control Latex Based Polymer of Example 1

Water based paint was made in the conventional procedure. This involved mixing 21.3 g Propylene glycol, 2.0 g water, 0.2 g Nipacide CFX, 0.2 g Dapro DF 4164 defoamer in a conventional twin shaft high speed disperser operating at a tip speed of 10 m/s for 10 minutes. To this, 0.60 g Natrosol 250 MHR (commercially available from Ashland Chemicals) and 1.5 g water was added and mixed for 15 minutes. To this 0.1 g Dapro DF 4164, 0.3 g Nonyl phenol 10 mole ethoxylate and 0.20 g AMP-95 was added and mixed for 15-20 minutes. To this 10 g of Sparkle Gold 4144 (commercially available from M/s Sudarshan Chemicals India Ltd) was added and mixing was done for a further period of 20 minutes. To this 4 g of Propylene glycol was added and mixing was continued for a further period of 50 minutes. To this 2.9 g Texanol was added and mixing continued for a further period of 20 minutes. To this 52.2 g emulsion of Example-1 was added and mixing was continued for a period of 40 minutes. Additives like Wacker BS 1306 and Troysan S97 were added, the respective quantities being 3 g and 0.5 g. To ensure complete transfer of additives 1 g water was used for rinsing.

Wet edge time was measured by applying a coat of paint over a portion of the wall, typical dimension being 1 ft by width and 2 ft by length. After a wait time of 3 minutes a fresh coat of same dimension was applied in which 6 inches by width was overlapping. In other words, on half the width the second coat is applied over the first coat. The overlap area was critically observed for appearance of ‘lap line’ along the entire length. If there are no lap lines visible then the wet edge time was greater than 3 minutes. This exercise was repeated at 1 minute increments followed by half minute increments to measure wet edge time to a least count of half minute. The measurements were carried out maintaining the temperature and humidity conditions to preset values.

The wet edge time was found to be 3 minutes at 38° C. and 30% Relative Humidity.

### EXAMPLE-8

### Paint Preparation Upon Incorporation of Latex Polymer of Example 6

Water based paint was made in the conventional procedure. This involved mixing 21.3 g Propylene glycol, 2.0 g water, 0.2 g Nipacide CFX, 0.2 g Dapro DF 4164 defoamer in a conventional twin shaft high speed disperser operating at a tip speed of 10 m/s for 10 minutes. To this, 0.60 g Natrosol 250 MHR (commercially available from Hercules Corporation) and 1.5 g water was added and mixed for 15 minutes. To this 0.1 g Dapro DF 4164, 0.3 g Nonyl phenol 10 mole ethoxylate and 0.20 g AMP-95 was added and mixed for 15-20 minutes. To this 10 g of Sparkle Gold 4144 (commercially available from M/s Sudarshan Chemicals India Ltd) was added and mixing was done for a further period of 20 minutes. To this 4 g of Propylene glycol was added and mixing was continued for a further period of 50 minutes. To this 2.9 g Texanol was added and mixing continued for a further period of 20 minutes. To this 52.2 g emulsion of Example-6 was added and mixing was continued for a period of 40 minutes. Additives like Wacker BS 1306 and Troysan S97 were added, the respective quantities being 3 g and 0.5 g. To ensure complete transfer of additives 1 g water was used for rinsing.

Wet edge time was measured by the method described in Example-7 and the same was found to be 3 minutes at 38° C. and 30% Relative Humidity.

### EXAMPLE-9

### Paint Preparation Upon Incorporation of the Latex Polymer of Example 2

Water based paint was made in the conventional procedure. This involved mixing 21.3 g Propylene glycol, 2.0 g water, 0.2 g Nipacide CFX, 0.2 g Dapro DF 4164 defoamer in a conventional twin shaft high speed disperser operating at a tip speed of 10 m/s for 10 minutes. To this, 0.60 g Natrosol 250 MHR (commercially available from Hercules Corporation) and 1.5 g water was added and mixed for 15 minutes. To this 0.1 g Dapro DF 4164, 0.3 g Nonyl phenol 10 mole ethoxylate and 0.20 g AMP-95 was added and mixed for 15-20 minutes. To this 10 g of Sparkle Gold 4144 (commercially available from M/s Sudarshan Chemicals India Ltd) was added and mixing was done for a further period of 20 minutes. To this 4 g of Propylene glycol was added and mixing was continued for a further period of 50 minutes. To this 2.9 g Texanol was added and mixing continued for a further period of 20 minutes. To this 52.2 g emulsion of Example-2 was added and mixing was continued for a period of 40 minutes. Additives like Wacker BS 1306 and Troysan S97 were added, the respective quantities being 3 g and 0.5 g. To ensure complete transfer of additives 1 g water was used for rinsing.

The wet edge time was determined as per the procedure described in Example-7. The result was found to be 6 minutes at 38° C. and 30% Relative Humidity.

### EXAMPLE-10

### Paint Preparation Upon Incorporation of the Latex Polymer of Example 3

Water based paint was made in the conventional procedure. This involved mixing 21.3 g Propylene glycol, 2.0 g water, 0.2 g Nipacide CFX, 0.2 g Dapro DF 4164 defoamer in a conventional twin shaft high speed disperser operating at a tip speed of 10 m/s for 10 minutes. To this, 0.60 g Natrosol 250 MHR (commercially available from Hercules Corporation) and 1.5 g water was added and mixed for 15 minutes. To this 0.1 g Dapro DF 4164, 0.3 g Nonyl phenol 10 mole ethoxylate and 0.20 g AMP-95 was added and mixed for 15-20 minutes. To this 10 g of Sparkle Gold 4144 (commercially available from M/s Sudarshan Chemicals India Ltd) was added and mixing was done for a further period of 20 minutes. To this 4 g of Propylene glycol was added and mixing was continued for a further period of 50 minutes. To this 2.9 g Texanol was added and mixing continued for a further period of 20 minutes. To this 52.2 g emulsion of Example-3 was added and mixing was continued for a period of 40 minutes. Additives like Wacker BS 1306 and Troysan S97 were added, the respective quantities being 3 g and 0.5 g. To ensure complete transfer of additives 1 g water was used for rinsing.

The wet edge time was determined as per the procedure described in Example-7. The result was found to be 6 minutes at 38° C. and 30% Relative Humidity.

### EXAMPLE-11

### Paint Preparation Upon Incorporation of the Latex Polymer of Example 4

Water based paint was made in the conventional procedure. This involved mixing 21.3 g Propylene glycol, 2.0 g water, 0.2 g Nipacide CFX, 0.2 g Dapro DF 4164 defoamer in a conventional twin shaft high speed disperser operating at a tip speed of 10 m/s for 10 minutes. To this, 0.60 g Natrosol 250 MHR (commercially available from Hercules Corporation) and 1.5 g water was added and mixed for 15 minutes. To this 0.1 g Dapro DF 4164, 0.3 g Nonyl phenol 10 mole ethoxylate and 0.20 g AMP-95 was added and mixed for 15-20 minutes. To this 10 g of Sparkle Gold 4144 (commercially available from M/s Sudarshan Chemicals India Ltd) was added and mixing was done for a further period of 20 minutes. To this 4 g of Propylene glycol was added and mixing was continued for a further period of 50 minutes. To this 2.9 g Texanol was added and mixing continued for a further period of 20 minutes. To this 52.2 g emulsion of Example-4 was added and mixing was continued for a period of 40 minutes. Additives like Wacker BS 1306 and Troysan S97 were added, the respective quantities being 3 g and 0.5 g. To ensure complete transfer of additives 1 g water was used for rinsing.

The wet edge time was determined as per the procedure described in Example-7. The result was found to be 6 minutes at 38° C. and 30% Relative Humidity.

### EXAMPLE-12

### Paint Preparation Upon Incorporation of the Latex Polymer of Example 5

Water based paint was made in the conventional procedure. This involved mixing 21.3 g Propylene glycol, 2.0 g water, 0.2 g Nipacide CFX, 0.2 g Dapro DF 4164 defoamer in a conventional twin shaft high speed disperser operating at a tip speed of 10 m/s for 10 minutes. To this, 0.60 g Natrosol 250 MHR (commercially available from Hercules Corporation) and 1.5 g water was added and mixed for 15 minutes. To this 0.1 g Dapro DF 4164, 0.3 g Nonyl phenol 10 mole ethoxylate and 0.20 g AMP-95 was added and mixed for 15-20 minutes. To this 10 g of Sparkle Gold 4144 (commercially available from M/s Sudarshan Chemicals India Ltd) was added and mixing was done for a further period of 20 minutes. To this 4 g of Propylene glycol was added and mixing was continued for a further period of 50 minutes. To this 2.9 g Texanol was added and mixing continued for a further period of 20 minutes. To this 52.2 g emulsion of Example-5 was added and mixing was continued for a period of 40 minutes. Additives like Wacker BS 1306 and Troysan S97 were added, the respective quantities being 3 g and 0.5 g. To ensure complete transfer of additives 1 g water was used for rinsing.

The wet edge time was determined as per the procedure described in Example-7. The result was found to be 5 minutes at 38° C. and 30% Relative Humidity.

### EXAMPLE-13

### Paint Preparation Upon Incorporation of Select Ingredients of the Present Invention Only in the Paint Preparation Stage and Control Latex Polymer of Example 1

Water based paint was made in the conventional procedure. This involved mixing 21.3 g Propylene glycol, 2.0 g water, 0.2 g Nipacide CFX, 0.2 g Dapro DF 4164 defoamer in a conventional twin shaft high speed disperser operating at a tip speed of 10 m/s for 10 minutes. To this, 0.60 g Natrosol 250 MHR (commercially available from Hercules Corporation) and 1.5 g water was added and mixed for 15 minutes. To this 0.1 g Dapro DF 4164, 0.3 g Nonyl phenol 10 mole ethoxylate and 0.20 g AMP-95 was added and mixed for 15-20 minutes. To this 10 g of Sparkle Gold 4144 (commercially available from M/s Sudarshan Chemicals India Ltd) was added and mixing was done for a further period of 20 minutes. To this 4 g of Propylene glycol was added and mixing was continued for a further period of 50 minutes. To this 2.9 g Texanol was added and mixing continued for a further period of 20 minutes. To this 52.2 g emulsion of Example-1 was added and mixing was continued for a period of 40 minutes. To this 1.90 g Atlas G 1086, 3 g Wacker BS 1306 and 0.5 g Troysan S97 were added and mixed for 5 minutes. To ensure complete transfer of additives 1 g water was used for rinsing.

The wet edge time was determined as per the procedure described in Example-7. The result was found to be 5 minutes at 38° C. and 30% Relative Humidity.

It can thus be clearly concluded from the above examples that the latex polymer emulsion preparations of Examples 1 and 6 that do not include the selective ingredient of the one or more embodiments of the invention when incorporated in the paint preparations of Examples 7 and 8 does not show the extension of wet edge time beyond 3 minutes whereas the latex polymer emulsions of Examples 2, 3, 4, 5 that include the selective ingredient the one or more embodiments of the invention, sorbitol ethoxylates esterified with fatty acids and subsequently incorporated in paint preparations of Examples 9, 10, 11, 12 reveals a wet edge time of at least 5 minutes or more.

It is also a notable finding of the one or more embodiments of the invention that, although Tween 80 consists of similar molecular components such as sorbitol, ethoxylate chain and fatty acid units as that of the selective ingredients (Atlas G-1086, Atlas G-1096) of the one or more embodiment of the invention which when added as an additive in the latex polymer emulsions of Example 6 that is subsequently incorporated in the paint preparations of Example 8 could not achieve the desired gain in wet edge time. The wet edge time was found to be just 3 minutes and very similar to the control latex polymer composition of Example 1 incorporated in the paint preparations of Example 7. However, in stark contrast to the attributes of Tween 80, the latex polymers of Examples 2, 3, 4, 5 involving the selective sorbitol ethoxylates esterified with fatty acids (Atlas G-1086, Atlas G-1096) when incorporated in the paint preparations of Examples 9, 10, 11, 12 reveals a wet edge time of at least 5 minutes or more vis-a-vis 3 minutes imparted by Tween 80.

Further to the above said, it was evident from the gain in wet edge times that in the paint preparations as per Example 13 when the selective ingredient of sorbitol ethoxylates esterified with fatty acids (Atlas G 1086) was added in the paint preparation stage vis-a-vis said ingredient being added in the latex polymer emulsion preparations as per examples 2, 3, 4, 5 further incorporated in the paint preparations of Examples 9, 10, 11, 12, the benefits in terms of the gain in wet edge time of the resultant paint preparation of the later is higher as compared to the said ingredient being added at the paint preparation stage.

Notably thus it was also found that the selective ingredient can be incorporated at more than one stages of latex polymer preparation with equal effectiveness in terms of the gain in wet edge time attained when incorporated in the paint preparations. More specifically, during the latex polymer emulsion preparation of Example 3 when the ingredient sorbitol ethoxylates esterified with fatty acids (Atlas G 1086) was added after the polymerization stage as compared to Examples 2, 4, 5 wherein selective ingredient were added during the polymerization stage itself while preparing the latex polymer emulsion, both the latex polymers of Example 3 and Examples 2, 4, 5 when further incorporated in the paint preparations of Example 10 and Examples 9, 11, 12 reveals equal effectiveness in extending the wet edge time of the paint preparations to at least 5 minutes or more.

It is thus possible by the technical advancement of the one or embodiments of the invention to achieve a synergistic emulsion formulation comprising a latex polymer derived from copolymerization of mono-ethylenically unsaturated monomers which in combination with selective of sorbitol ethoxylates esterified with fatty acids as an ingredient in the formulation is adapted for facilitating achieving a desired open time or wet edge time of any aqueous coating/paint composition on application to thus result in improved workability of said paint/coating compositions.

The synergistic benefits of achieving the desired gain in open time or wet edge time by the said formulation/composition on application due to the incorporation of selective ingredients comprising a latex polymer derived from copolymerization of mono-ethylenically unsaturated monomers in combination with selective sorbitol ethoxylates esterified with fatty acids can even be achieved when the paint/coating composition involves other conventional ingredients of surfactants, pigments and other optional additives.

Advantageously, said selective ingredients of said synergistic emulsion formulation of the one or more embodiments of the invention when incorporated in coating/paint compositions favor slowing down of water evaporation from said coatings/paint composition considerably on application such that the same remains amenable to touch up due to the desired gain in open time or wet edge time thus achieved. More advantageously, the selective ingredients offer flexibility of incorporation and can be incorporated either at the stage of latex polymer emulsion preparation or may be incorporated during paint preparation stage wherein the benefits in terms of the gain in open time or wet edge time is higher if incorporated at the stage of polymer emulsion preparation as opposed to their incorporation during paint preparation stage and wherein the selective ingredients can be incorporated at more than one stage of latex polymer emulsion preparation imparting equal effectiveness to the improvement in open time or wet edge time.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

1. A synergistic emulsion formulation adapted for facilitating achieving desired open time or wet edge time of any aqueous coating/paint composition on application comprising a latex copolymer in combination with sorbitol ethoxylates esterified with fatty acids.

2. The synergistic emulsion formulation according to claim 1, wherein the sorbitol ethoxylates esterified with fatty acids is selected from a class of sorbitol ethoxylates esterified with fatty acids having the general formula, C₆H₈(OH)_{6-b}(OCH₂CH₂)ₘ(R¹COO)_{b}, wherein b is an integer from 1 to 6, R¹ is a hydrocarbon group comprising a straight chain of alkyl groups having 6 to 22 carbon atoms and m is in the range of 4 to 60.

3. The synergistic emulsion formulation according to claim 2, wherein the number of oxyethylene groups (OCH₂CH₂) denoted by the value m is preferably in the range 40 to 60.

4. The synergistic emulsion formulation according to claim 1, wherein the sorbitol ethoxylates esterified with fatty acids are incorporated in the amounts of 0.1% to 10% in the formulation.

5. The synergistic emulsion formulation according to claim 1, wherein the latex copolymer is film forming, and wherein the latex copolymer having a glass transition temperature in the range of −15° C. to +50° C. is obtained from ethylenically unsaturated monomers.

6. The synergistic emulsion formulation according to claim 1, wherein the latex copolymer is obtained from ethylenically unsaturated monomers selected from at least one or more of: a) acrylic acid esters and methacrylic acid esters of alcohols having 1 to 18 carbon atoms;
b) hydroxy alkyl acrylates;
c) mono ethylenically unsaturated hydrocarbons; and
d) acid monomers.

7. A process of manufacturing a synergistic emulsion formulation according to claim 1, involving latex copolymer comprising ethylenically unsaturated monomers and select sorbitol ethoxylates esterified with fatty acids, and wherein the step of providing the sorbitol ethoxylates esterified with fatty acids in combination with a latex copolymer comprises either:
(i) incorporating the sorbitol ethoxylate esterified with the fatty acid at the time of polymerization; or
(ii) incorporating the sorbitol ethoxylates esterified with the fatty acid post polymerization.

8. A synergistic aqueous coating/paint composition having a desired open time or wet edge time on application comprising:
(a) a synergistic emulsion formulation comprising a latex copolymer in combination with sorbitol ethoxylates esterified with fatty acids; and
(b) a coating/paint formulation.

9. The synergistic aqueous coating/paint composition according to claim 9, wherein the desired open time or wet edge time of the composition on application is in the range of 5 to 6 minutes.

10. A process of manufacturing the synergistic aqueous coating/paint composition having the desired open time or wet edge time on application according to claim 9, comprising the steps of:
(i) providing the synergistic emulsion formulation comprising a latex copolymer in combination with sorbitol ethoxylates esterified with fatty acids; and
(ii) adding the synergistic emulsion formulation from step (i) to the aqueous coating/paint formulation.

11. A process of manufacturing the synergistic aqueous coating/paint composition having the desired open time or wet edge time on application according to claim 9 comprising the steps of:
I. preparing the latex copolymers involving the steps of:
(a) providing one or more monomers for polymerization; and
(b) obtaining the latex copolymers therefrom, comprising pre-emulsion of the latex copolymers; and
II. preparing the synergistic aqueous coating/paint composition involving the sorbitol ethoxylate esterified with the fatty acids and the latex copolymer obtained from step (I).

12. The process of manufacturing the synergistic aqueous coating/paint composition according to claim 11, wherein the sorbitol ethoxylates esterified with fatty acids are incorporated in the amounts of 0.1% to 10% in the composition.

13. A method of coating/painting any surface using the synergistic emulsion formulation adapted for facilitating achieving a desired open time or wet edge time according to claim 1, comprising the steps of:
(i) providing the emulsion formulation comprising a latex copolymer in combination with the sorbitol ethoxylates esterified with fatty acids; and
(ii) incorporating the emulsion formulation in a coating/paint formulation and thereafter applying it on a surface to attain the desired open time or wet edge time, the desired open time or wet edge in the range of 5 to 6 minutes.
